(19) United States
(12) Patent Application Publication
(10) Pub. No.: US 2018/0186358 A1
(43) Pub. Date: Jul. 5, 2018

(54) Method For Control Of A Ball Planetary Type Continuously Variable Transmission Using Fuzzy Logic

(71) Applicant: Dana Limited, Maumee, OH (US)

(72) Inventor: Jeffrey M. David, Cedar Park, TX (US)

(21) Appl. No.: 15/848,554

(22) Filed: Dec. 20, 2017

Related U.S. Application Data
(60) Provisional application No. 62/441,726, filed on Jan. 3, 2017.

(51) Int. Cl. B60W 10/103; F16H 59/36; F16H 61/02; G06N 7/02

(52) U.S. Cl. CPC B60W 10/103; F16H 59/36; B60W 2050/0012; G06N 7/02; F16H 61/0213

(57) ABSTRACT

Provided herein is a method and control system for a multiple-mode continuously variable transmission having a ball planetary variator. The control system has a transmission control module configured to receive a plurality of electronic input signals, and to determine a mode of operation from a plurality of control ranges based at least in part on the plurality of electronic input signals. The transmission control module includes a CVP control module. The CVP control module is adapted to implement a hydraulic pressure control process using fuzzy logic computations for operating in a micro slip speed region of the CVP. The fuzzy logic computations include determining weighting coefficients that are applied to minimum and maximum hydraulic pressure limits in the transmission.

### RELATED APPLICATION

The present application claims the benefit of U.S. Provisional Application No. 62/441,726 filed on Jan. 3, 2017, which is incorporated herein by reference in its entirety.

### BACKGROUND

Continuously variable transmissions (CVT) and transmissions that are substantially continuously variable are increasingly gaining acceptance in various applications. The process of controlling the ratio provided by the CVT is complicated by the continuously variable or minute gradations in ratio presented by the CVT. Furthermore, the range of ratios that are available to be implemented in a CVT are not sufficient for some applications. A transmission is capable of implementing a combination of a CVT with one or more additional CVT stages, one or more fixed ratio range splitters, or some combination thereof in order to extend the range of available ratios. The combination of a CVT with one or more additional stages further complicates the ratio control process, as the transmission will have multiple configurations that achieve the same final drive ratio.

The different transmission configurations may for example, multiply input torque across the different transmission stages in different manners to achieve the same final drive ratio. However, some configurations provide more flexibility or better efficiency than other configurations providing the same final drive ratio.

Modern day control systems for machinery have incorporated a variety of computational control methods including methods known as “fuzzy logic”. Typical fuzzy logic methods recognize more than simple true and false values in computing commands. A continuously variable planetary (CVP) slip speed controller incorporating fuzzy logic has the advantage of automatic adaptation to changing operating conditions which would ordinarily be outside the scope of a control system. For example, in the case of CVP lube pressure command, a control method is described herein that alters pressure commands in response to CVP slip speed and the rate of change of the CVP slip speed. Because CVP slip speeds are a function of multiple factors (ratio, torque, input speed, road load, output torque disturbances, etc.), the control is automatically adaptive to all of these conditions. In a conventional pressure control scheme it is possible to set an open loop pressure schedule as a function of multiple variables, however, the set is limited to only what the controller can directly measure

### SUMMARY

A control system for a CVP incorporating a fuzzy logic method will be described herein. By reacting to the net effect of all disturbances (measurable and otherwise) the fuzzy logic controller provides that the parameters can be tuned to always allow a very small amount of slip in the CVP. If the control system has the bandwidth to react appropriately fast, the CVP can be operated in the micro slip range allowing for more torque to be transmitted at a given lube pressure. Thus, CVP flow induced losses are minimized and net system efficiency is increased.

Provided herein is a method for controlling a continuously variable transmission having a ball-planetary variator (CVP) provided with a ball in contact with a first traction ring assembly, a second traction ring assembly, and an idler assembly, wherein the continuously variable transmission is operably coupled to a pressurized hydraulic system, the method including the steps of: receiving a plurality of input signals indicative of a CVP input speed and a CVP slip speed; evaluating rate of change of the CVP slip speed; determining a CVP slip state based on a fuzzy logic computation; applying a plurality of fuzzy logic weighting coefficients indicative of the CVP slip state; determining a hydraulic pressure setpoint based on the plurality of fuzzy logic weighting coefficients; and issuing the hydraulic pressure setpoint as a command to impart a change in the operating condition of the CVP.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

Novel features of the preferred embodiments are set forth with particularity in the appended claims. A better understanding of the features and advantages of the present embodiments will be obtained by reference to the following detailed description that sets forth illustrative embodiments, in which the principles of the devices are utilized, and the accompanying drawings of which:

FIG. 1 is a side sectional view of a ball-type variator.

FIG. 2 is a plan view of a carrier member that used in the variator of FIG. 1.

FIG. 3 is an illustrative view of different tilt positions of the ball-type variator of FIG. 1.

FIG. 4 is a block diagram schematic of a vehicle control system that could be implemented in a vehicle.

FIG. 5 is a block diagram of a lubricant pressure controller having a fuzzy logic controller.

FIG. 6 is a block diagram of another lubricant pressure controller having a fuzzy logic controller.

FIG. 7 is a graph of traction coefficient versus CVP slip.

FIG. 8 is a block diagram of a fuzzy logic controller.

FIG. 9 is a chart depicting weighted coefficients versus CVP slip for slip speed membership sets used in the fuzzy logic controller of FIG. 8.

FIG. 10 is a chart depicting weighted coefficients versus CVP slip for slip rate of change membership sets used in the fuzzy logic controller of FIG. 8.

FIG. 11 is a flow chart for a hydraulic piston pressure control process.

FIG. 12 is a high level block diagram of a CVP slip speed calculation implementable in the fuzzy logic controllers of FIG. 5 or FIG. 6.

FIG. 13 is a block diagram of the CVP slip speed calculation of FIG. 12.

### DETAILED DESCRIPTION OF THE PREFERRED EMBODIMENTS

An electronic controller is described herein that enables electronic control over a variable ratio transmission having a continuously variable ratio portion, such as a Continuously Variable Transmission (CVT), Infinitely Variable Transmission (IVT), or variator. The electronic controller can be configured to receive input signals indicative of parameters associated with an engine coupled to the transmission. The parameters can include throttle position sensor values, accelerator pedal position sensor values, vehicle speed, gear selector position, user-selectable mode configurations, and the like, or some combination thereof. The electronic controller can also receive one or more control inputs. The electronic controller can determine an active range and an active variator mode based on the input signals and control inputs. The electronic controller can control a final drive ratio of the variable ratio transmission by controlling one or more electronic actuators and/or solenoids that control the ratios of one or more portions of the variable ratio transmission.

The electronic controller described herein is described in the context of a continuous variable transmission, such as the continuous variable transmission of the type described in U.S. patent application Ser. No. 14/425,842, entitled “3-Mode Front Wheel Drive And Rear Wheel Drive Continuously Variable Planetary Transmission” and, U.S. patent application Ser. No. 15/572,288 entitled “Control Method of Synchronous Shifting of a Multi-Range Transmission Comprising a Continuously Variable Planetary Mechanism”, each assigned to the assignee of the present application and hereby incorporated by reference herein in its entirety. However, the electronic controller is not limited to controlling a particular type of transmission but rather, is optionally configured to control any of several types of variable ratio transmissions.

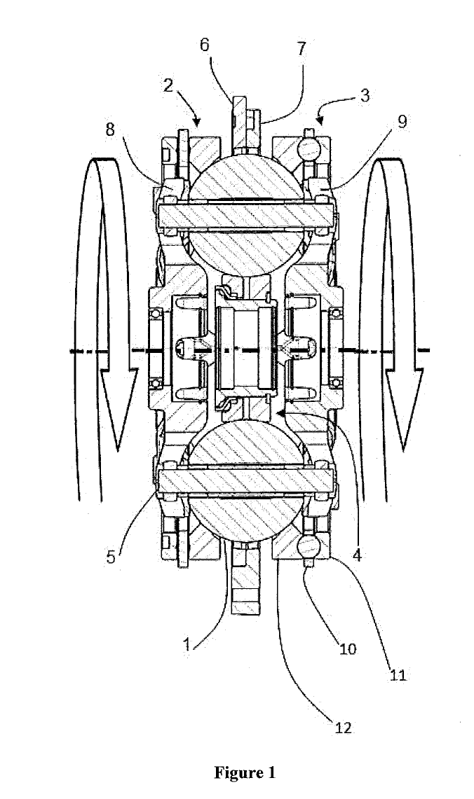

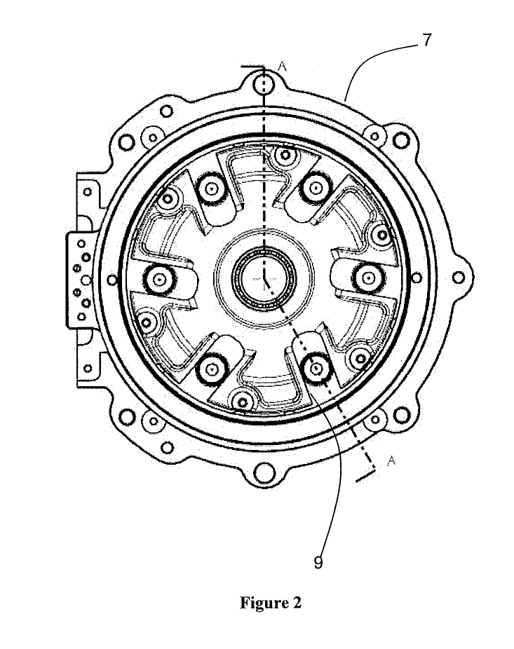

Provided herein are configurations of CVTs based on a ball type variator, also known as CVP, for continuously variable planetary. Basic concepts of a ball type Continuously Variable Transmissions are described in U.S. Pat. Nos. 8,469,856 and 8,870,711 incorporated herein by reference in their entirety. Such a CVT, adapted herein as described throughout this specification, includes a number of balls (planets, spheres) 1, depending on the application, two ring (disc) assemblies with a conical surface contact with the balls, as input traction ring assembly 2 and output traction ring assembly 3, and an idler (sun) assembly 4 as shown on FIG. 1. In some embodiments, the output traction ring assembly 3 includes an axial force generator mechanism. The balls are mounted on tiltable axles 5, themselves held in a carrier (stator, cage) assembly having a first carrier member 6 operably coupled to a second carrier member 7. The first carrier member 6 rotates with respect to the second carrier member 7, and vice versa. In some embodiments, the first carrier member 6 is substantially fixed from rotation while the second carrier member 7 is configured to rotate with respect to the first carrier member, and vice versa. In one embodiment, the first carrier member 6 is provided with a number of radial guide slots 8. The second carrier member 7 is provided with a number of radially offset guide slots 9, as illustrated in FIG. 2. The radial guide slots 8 and the radially offset guide slots 9 are adapted to guide the tiltable axles 5. The axles 5 are adjustable to achieve a desired ratio of input speed to output speed during operation of the CVT. In some embodiments, adjustment of the axles 5 involves control of the position of the first and second carrier members to impart a tilting of the axles 5 and thereby adjusts the speed ratio of the variator. Other types of ball CVTs also exist, like the one produced by Milner, but are slightly different.

The working principle of such a CVP of FIG. 1 is shown on FIG. 3. The CVP itself works with a traction fluid. The lubricant between the ball and the conical rings acts as a solid at high pressure, transferring the power from the input ring, through the balls, to the output ring. By tilting the balls' axes, the ratio is changed between input and output. When the axis is horizontal, the ratio is one, as illustrated in FIG. 3, when the axis is tilted, the distance between the axis and the contact point change, modifying the overall ratio. All the balls' axes are tilted at the same time with a mechanism included in the carrier and/or idler. Embodiments disclosed herein are related to the control of a variator and/or a CVT using generally spherical planets each having a tiltable axis of rotation that is adjustable to achieve a desired ratio of input speed to output speed during operation.

In some embodiments, adjustment of said axis of rotation involves angular misalignment of the planet axis in a first plane in order to achieve an angular adjustment of the planet axis in a second plane that is substantially perpendicular to the first plane, thereby adjusting the speed ratio of the variator. The angular misalignment in the first plane is referred to here as “skew”, “skew angle”, and/or “skew condition”. In one embodiment, a control system coordinates the use of a skew angle to generate forces between certain contacting components in the variator that will tilt the planet axis of rotation. The tilting of the planet axis of rotation adjusts the speed ratio of the variator.

As used here, the terms “operationally connected,” “operationally coupled”, “operationally linked”, “operably connected”, “operably coupled”, “operably coupleable”, “operably linked,” and like terms, refer to a relationship (mechanical, linkage, coupling, etc.) between elements whereby operation of one element results in a corresponding, following, or simultaneous operation or actuation of a second element. It is noted that in using said terms to describe the embodiments, specific structures or mechanisms that link or couple the elements are typically described. However, unless otherwise specifically stated, when one of said terms is used, the term indicates that the actual linkage or coupling will take a variety of forms, which in certain instances will be readily apparent to a person of ordinary skill in the relevant technology.

For description purposes, the term “radial”, as used herein indicates a direction or position that is perpendicular relative to a longitudinal axis of a transmission or variator. The term “axial” as used herein refers to a direction or position along an axis that is parallel to a main or longitudinal axis of a transmission or variator.

It should be noted that reference herein to “traction” does not exclude applications where the dominant or exclusive mode of power transfer is through “friction.” Without attempting to establish a categorical difference between traction and friction drives herein, generally, these are understood as different regimes of power transfer. Traction drives usually involve the transfer of power between two elements by shear forces in a thin fluid layer trapped between the elements. The fluids used in these applications usually exhibit traction coefficients greater than conventional mineral oils. The traction coefficient (μ) represents the maximum available traction forces that would be available at the interfaces of the contacting components and is a measure of the maximum available drive torque. Typically, friction drives generally relate to transferring power between two elements by frictional forces between the elements. For the purposes of this disclosure, it should be understood that the CVTs described here can operate in both tractive and frictional applications. As a general matter, the traction coefficient μ is a function of the traction fluid properties, the normal force at the contact area, and the velocity of the traction fluid in the contact area, among other things. For a given traction fluid, the traction coefficient μ increases with increasing relative velocities of components, until the traction coefficient μ reaches a maximum capacity after which the traction coefficient decays. The condition of exceeding the maximum capacity of the traction fluid is often referred to as “gross slip condition”. Traction fluid is also influenced by entrainment speed of the fluid and temperature at the contact patch, for example, the traction coefficient is generally highest near zero speed and decays as a weak function of speed. The traction coefficient often improves with increasing temperature until a point at which the traction coefficient rapidly degrades.

As used herein, “creep”, “ratio droop”, or “slip” is the discrete local motion of a body relative to another and is exemplified by the relative velocities of rolling contact components such as the mechanism described herein. In traction drives, the transfer of power from a driving element to a driven element via a traction interface requires creep. Usually, creep in the direction of power transfer, is referred to as “creep in the rolling direction.” Sometimes the driving and driven elements experience creep in a direction orthogonal to the power transfer direction, in such a case this component of creep is referred to as “transverse creep.”

Those of skill will recognize that the various illustrative logical blocks, modules, circuits, and algorithm steps described in connection with the embodiments disclosed herein, including with reference to the transmission control system described herein, for example, can be implemented as electronic hardware, software stored on a computer readable medium and executable by a processor, or combinations of both. To clearly illustrate this interchangeability of hardware and software, various illustrative components, blocks, modules, circuits, and steps have been described herein generally in terms of their functionality. Whether such functionality is implemented as hardware or software depends upon the particular application and design constraints imposed on the overall system. Skilled artisans can implement the described functionality in varying ways for each particular application, but such implementation decisions should not be interpreted as causing a departure from the scope of the present embodiments. For example, various illustrative logical blocks, modules, and circuits described in connection with the embodiments disclosed herein could be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor could be a microprocessor, but in the alternative, the processor could be any conventional processor, controller, microcontroller, or state machine. A processor could also be implemented as a combination of computing devices, e.g., a combination of a DSP and a microprocessor, a plurality of microprocessors, one or more microprocessors in conjunction with a DSP core, or any other such configuration. Software associated with such modules could reside in RAM memory, flash memory, ROM memory, EPROM memory, EEPROM memory, registers, a hard disk, a removable disk, a CD-ROM, or any other suitable form of storage medium known in the art. An exemplary storage medium is coupled to the processor such the processor reads information from, and write information to, the storage medium. In the alternative, the storage medium could be integral to the processor. The processor and the storage medium could reside in an ASIC. For example, in one embodiment, a controller for use of control of the CVT includes a processor (not shown).

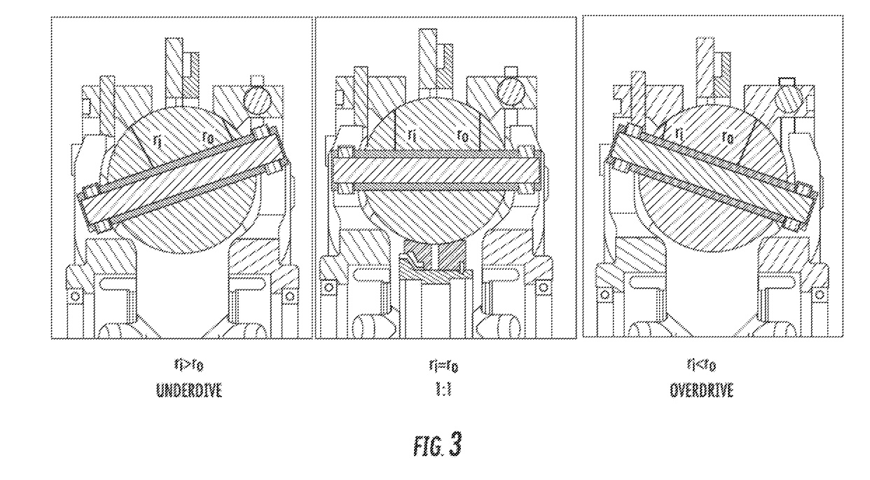

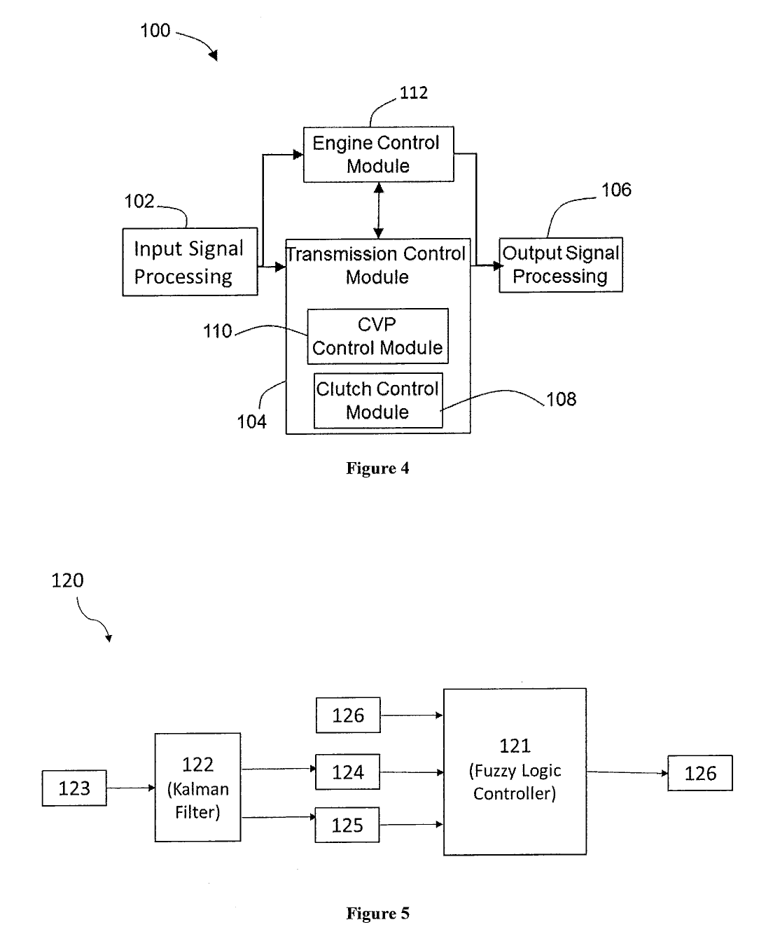

Referring now to FIG. 4, in some embodiments, a vehicle control system 100 includes an input signal processing module 102, a transmission control module 104 and an output signal processing module 106. The input signal processing module 102 is configured to receive a number of electronic signals from sensors provided on the vehicle and/or transmission. The sensors optionally include temperature sensors, speed sensors, position sensors, among others. In some embodiments, the signal processing module 102 optionally includes various sub-modules to perform routines such as signal acquisition, signal arbitration, or other known methods for signal processing. The output signal processing module 106 is optionally configured to electronically communicate to a variety of actuators and sensors. In some embodiments, the output signal processing module 106 is configured to transmit commanded signals to actuators based on target values determined in the transmission control module 104. The transmission control module 104 optionally includes a variety of sub-modules or sub-routines for controlling continuously variable transmissions of the type discussed here. For example, the transmission control module 104 optionally includes a clutch control sub-module 108 that is programmed to execute control over clutches or similar devices within the transmission. In some embodiments, the clutch control sub-module implements state machine control for the coordination of engagement of clutches or similar devices. The transmission control module 104 optionally includes a CVP control sub-module 110 programmed to execute a variety of measurements and determine target operating conditions of the CVP, for example, of the ball-type continuously variable transmissions discussed here. It should be noted that the CVP control sub-module 110 optionally incorporates a number of sub-modules for performing measurements and control of the CVP. In some embodiments, the vehicle control system 100 includes an engine control module 112 configured to receive signals from the input signal processing module 102 and in communication with the output signal processing module 106. The engine control module 112 is configured to communicate with the transmission control module 104.

Referring now to FIG. 5, in some embodiments, the CVP control sub-module 110 incorporates a lubricant pressure controller 120. The lubricant pressure controller 120 includes a fuzzy logic controller 121 in communication with a kalman filter 122. The kalman filter 122 receives a CVP slip speed signal 123 from other sub-modules in the transmission control module 104 or the CVP control sub-module 120. The kalman filter 122 transmits a filtered CVP slip signal 124 and a slip acceleration signal 125 (sometimes referred to herein as “dSlip speed”) to the fuzzy logic controller 121. A Kalman filter has both filtering and predictive estimation properties. This is ideally suited to an application where noise removal and fast response to disturbances are equally important. The fuzzy logic controller 121 receives a CVP input speed signal 126 from other sub-modules in the transmission control module 104 or the CVP control sub-module 120. The fuzzy logic controller 121 determines a pressure command signal 127 that is sent to adjust the lubricant pressure in the transmission.

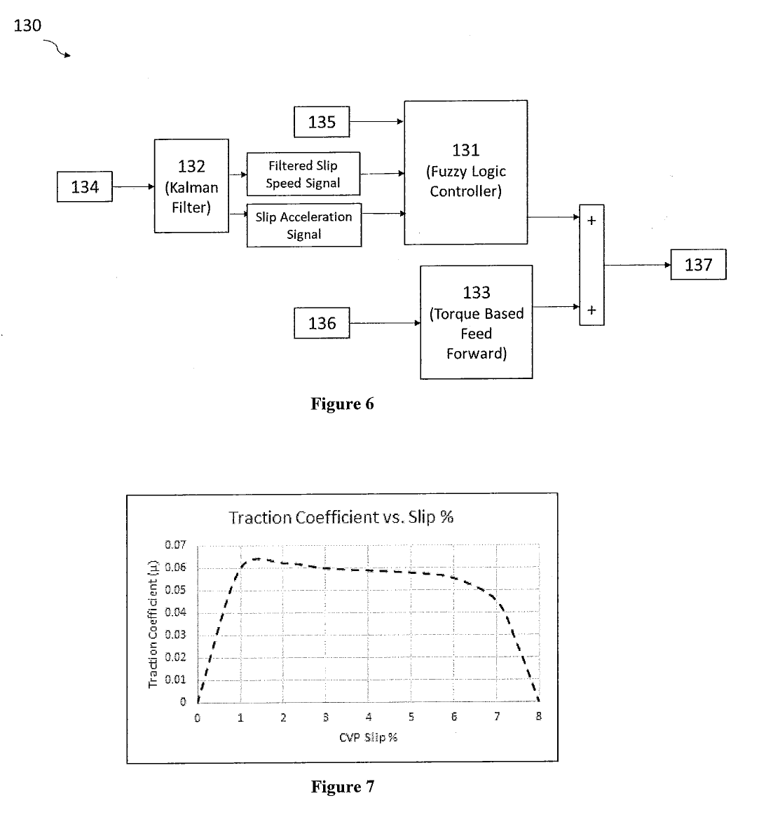

Referring now to FIG. 6, in some embodiments, the CVP control sub-module 110 incorporates a lubricant pressure controller 130. The lubricant pressure controller 130 includes a fuzzy logic controller 131 in communication with a kalman filter 132. In some embodiments, the lubricant pressure controller 130 includes a torque based feedforward module 133. The kalman filter 132 receives a CVP slip speed signal 134 from other sub-modules in the transmission control module 104 or the CVP control sub-module 120. The kalman filter 132 transmits a filtered CVP slip signal and a slip acceleration signal (sometimes referred to herein as “dSlip speed”) to the fuzzy logic controller 131. The fuzzy logic controller 131 receives a CVP input speed signal 135 from other sub-modules in the transmission control module 104 or the CVP control sub-module 130. The torque based feedforward module 133 receives a CVP input torque signal 136 from other sub-modules in the transmission control module 104 or the CVP control sub-module 130. The fuzzy logic controller 131 determines a pressure command signal that is added to the pressure command signal determined by the torque based feedforward module 133 to for a pressure command signal 137. During operation, the combined delay in the feedback signal plus the microprocessor loop time may result in an unacceptable response time for feedback only control. Slip speed feedback control can be combined with feed forward open loop control techniques based on measurable input signals leaving the feedback control with much less correction needed to counteract measurable torque disturbances.

Referring now to FIG. 7, in some embodiments, the fuzzy logic controller 121, or the fuzzy logic controller 131, is adapted to control parameters to consistently allow a very small amount of slip in the CVP. Assuming that the control system, such as the vehicle control system 100, has the bandwidth to react appropriately fast, the CVP can be operated in a micro slip range. As used herein, the term “micro slip range” is the range of slip in the CVP that is in the range of 0 to 1%. Operation in the micro slip range allows more torque to be transmitted for a given lube pressure. It should be appreciated, that a CVP such as the CVP described in reference to FIGS. 1-3, is provided with a pressurized hydraulic lubrication system supplying the traction contacts between the balls and the traction rings with a traction fluid. Thus, when operating in the micro slip range, the CVP flow induced losses are minimized and net system efficiency is increased. FIG. 7 depicts a graph of the traction coefficient on the y-axis and a CVP slip along the x-axis. Note, as discussed above in reference to FIGS. 1-3, that the peak traction coefficient occurs at some small slip value followed by a linear reduction with increased slip. Finally, at a large slip value the traction coefficient drops off suddenly. In some embodiments, additional logic can be implemented allowing micro slip operation only in operating conditions where efficiency is prioritized over power capacity. Under heavy load operating conditions, lubricant flow is increased for power capacity or thermal considerations.

In some embodiments, the fuzzy logic controller uses a slip speed calculation to determine a commanded speed ratio of the CVP. The slip speed (Nₛₗᵢₚ) definition is provided in the equation below, where N_{R1} is the speed of the first traction ring, N_{R2} is the speed of the second traction ring, and SR_{command} is the commanded speed ratio. Under positive engine torque, the equation results in a positive value whereas under negative engine torque the result is negative. For control purposes the absolute value of both the slip speed and slip rate of change are used.

Nₛₗᵢₚ=N_{R1}−N_{R2}*SR_{command}

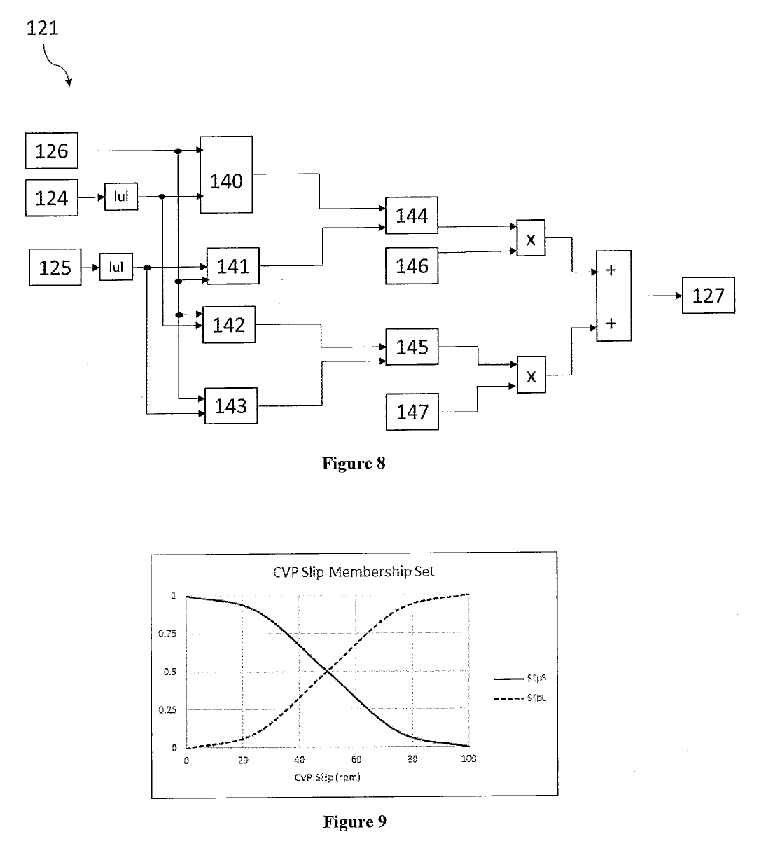

Turning now to FIG. 8, in some embodiments, the fuzzy logic controller 121 includes a small slip speed membership set 140, a small slip rate of change membership set 141, a large slip speed membership set 142, and a large slip rate of change membership set 143. The small slip speed membership set 140 and the small slip rate of change membership set 141 pass signals to a first rule function 144. The large slip speed membership set 142 and the large slip rate of change membership set 143 pass signals to a second rule function 145. The first rule function 144 passes a signal to be multiplied by a minimum lubricant pressure variable 146. The second rule function block 145 passes a signal to be multiplied by a maximum lubricant pressure variable 147. The summation of the two products results in the CVP lube pressure command signal 127.

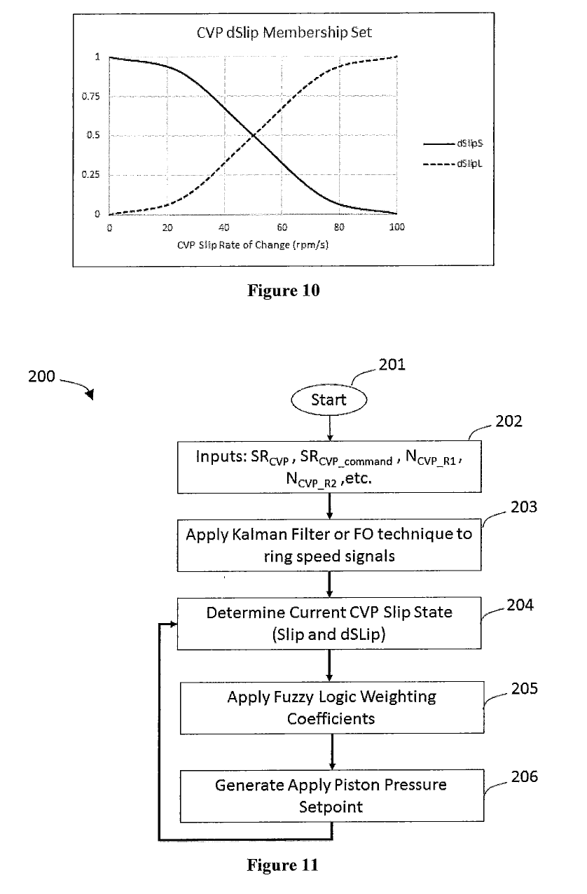

Referring now to FIGS. 9 and 10, fuzzy logic membership sets such as the small slip speed membership set 140, the small slip rate of change membership set 141, the large slip speed membership set 142, and the large slip rate of change membership set 143 will be discussed. Conventional logic states that a measured value is either small or large (0 or 1) and is based on a defined constant for comparison. Fuzzy logic allows for a measured value that is assigned a degree of smallness (between 0 and 1) and a degree of largeness (between 0 and 1) simultaneously. FIGS. 9 and 10 depict a function for each membership set that assigns a weight to a particular measured value. In FIG. 9, membership sets for measured slip speed are shown that assign the degree of smallness (depicted as the curve labeled “SlipS” and indicative of the small slip speed membership set 140) and largeness (depicted as the curve labeled “SlipL” and indicative of the large slip speed membership set 142). Similarly, as shown in FIG. 10, weights are assigned to the measured slip rate of change for the degree of smallness (depicted as the curve labeled “dSlipS” and indicative of the small slip rate of change membership set 141) and the degree of largeness (depicted as the curve labeled “dSlipL” and indicative of the large slip rate of change membership set 143).

Sensitivity to slip speed or slip rate of change is adjusted by modifying the respective horizontal axis of the set. In some embodiments, the membership sets are implemented as two dimensional look up tables. For example, a specific value of slip at a low input speed is weighted lower in the SlipS table than the exact same slip speed value if it were to occur at a higher input speed. The reverse is true for the SlipL table. A similar speed dependent adjustment is specified for the dSlipS and dSlipL tables. Note that for clarity the examples shown in FIGS. 9 and 10 are one dimensional only and thus are applicable to a single fixed input speed.

Still referring to FIGS. 8-10, a particular measured value of slip is evaluated with the membership sets SlipS and SlipL, for example, the small slip speed membership set 140 and the large slip speed membership set 142. Similarly, the current slip rate of change is evaluated with the membership sets dSlipS and dSlipL, for example, the small slip rate of change membership set 141 and the large slip rate of change membership set 143. It is understood that if the slip is small and the rate of change of slip is small then the pressure command should be low. In some embodiments, the first rule function 144 is implemented using the following relationship:

Rule 1: IF Slip is S AND dSlip is S, THEN Pₛₑₜₚₒᵢₙₜ is min

However, when either the slip or slip rate of change is large it is understood that the pressure command should be high. In some embodiments, the second rule function 145 is implemented using the following relationship:

Rule 2: IF Slip is L OR dSlip is L, THEN Pₛₑₜₚₒᵢₙₜ is max

The determination of weighting coefficients is done by applying the rules of fuzzy logic. An AND condition between two values is treated as a minimum function. An OR condition is treated as a maximum function. Thus, the evaluation of the rules yields the weighting coefficients shown below.

Cₘᵢₙ=min(SlipS, dSlipS) from the first rule function 144

Cₘₐₓ=max(SlipL, dSlipL) from the second rule function 145

The sum of the min and max coefficients multiplied by the respective physical constants produces a pressure setpoint between Pₘᵢₙ and Pₘₐₓ as shown in the following equation.

Pₛₑₜₚₒᵢₙₜ=Cₘᵢₙ*Pₘᵢₙ+Cₘₐₓ*Pₘₐₓ

Passing now to FIG. 11, in some embodiments, a control process 200 is implementable on a transmission system having active hydraulic clamping methods such as those described in Patent Cooperation Treaty Application No. PCT/US2017/055,868, which is hereby incorporated by reference. A hydraulic clamping force piston under active control has control authority to affect change in slip speed. Implementation of the embodiments disclosed herein in reference to FIGS. 5-10 to the control of hydraulic clamping force piston is illustrated in the control process 200. It should be understood that the discussion and description of implementing fuzzy logic disclosed herein is applicable in the control process 200. In some embodiments, the control process 200 begins at a start state 201 and proceeds to a block 202 where a number of input signals are received. For example, the input signals include a current CVP speed ratio, a commanded CVP speed ratio, a first traction ring speed, a second traction ring speed, among others. The control process 200 proceeds to a block 203 where a Kalman filter or other filter technique is applied to the traction ring speed signals. The control process 200 proceeds to a block 204 where current CVP slip states are determined. For example, CVP slip states include slip speed and slip rate of change. The control process 200 proceeds to a block 205 where fuzzy logic weighting coefficients are applied. The control process 200 proceeds to a block 206 where a commanded piston pressure is determined based on the fuzzy logic weighting coefficients. The control process 200 returns to the block 204.

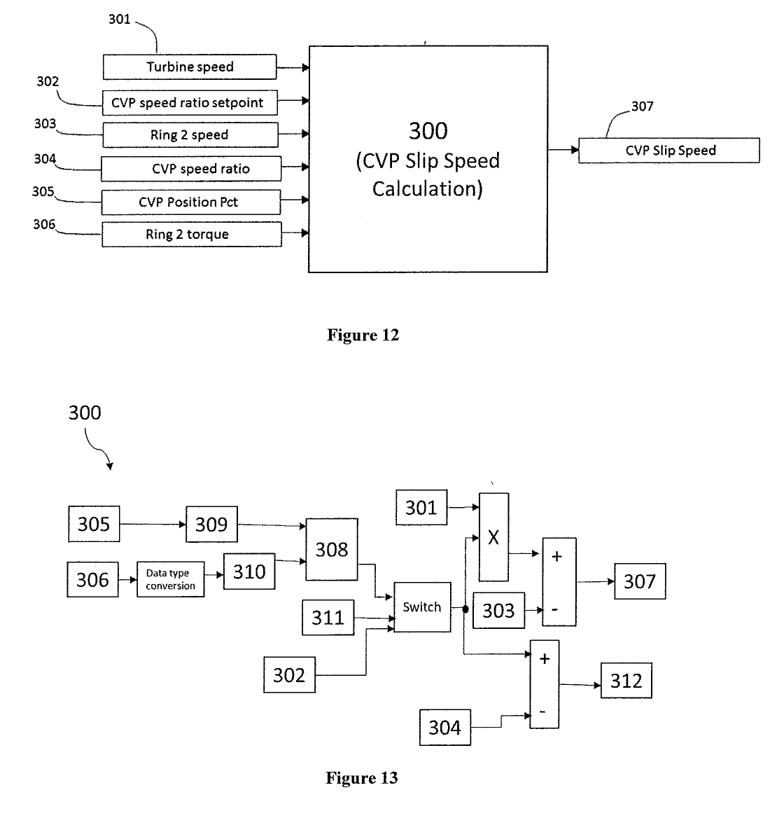

Turning now to FIGS. 12 and 13, in some embodiments, the fuzzy logic controller 121, or the fuzzy logic controller 131, implements a CVP slip speed calculation sub-module 300. The CVP slip speed calculation sub-module 300 is adapted to receive a number of signals from other control modules in the transmission controller 104. In some embodiments, the input signals include a turbine speed 301, a CVP speed ratio setpoint 302, a second traction ring speed 303, a current CVP speed ratio 304, a CVP position 305 and a second traction ring torque 306. The CVP slip speed calculation sub-module 300 returns a CVP slip speed 307. It should be appreciated that the CVP slip speed 307 is optionally used in place of the CVP slip speed 123 or the CVP slip speed 134. In some embodiments, the CVP slip speed calculation sub-module 300 includes a ratio-to-position reverse look-up table 308 containing data for a CVP speed ratio based on the CVP position 305 and the second traction ring torque 308. In some embodiments, the CVP position 305 is passed to a position index look-up table 309 to determine a position based index input for the ratio-to-position reverse look-up table 308. In some embodiments, the second traction ring torque 306 is passed to a torque based index look-up table 310 to determine a torque based index input for the ratio-to-position reverse look-up table 308. The ratio-to-position reverse look-up table 308 determines an expected CVP speed ratio based on the CVP position and the torque on the second traction ring. In some embodiments, the CVP slip speed calculation sub-module 300 includes a switch control 311 to determine if the output of the ratio-to-position reverse look-up table 308 or the current speed ratio setpoint 302 are used in the CVP slip calculation. The switch control 311 passes the output to be subtracted from the current CVP speed ratio 304 to determine a CVP speed ratio error 312. The switch control 311 passes the output to be multiplied by the turbine speed 301 to form a product. To calculate the CVP slip speed 307, the second traction ring speed 303 is subtracted from the product.

The foregoing description details certain embodiments. It will be appreciated, however, that no matter how detailed the foregoing appears in text, the preferred embodiments are practiced in many ways. As is also stated above, it should be noted that the use of particular terminology when describing certain features or aspects of the preferred embodiments should not be taken to imply that the terminology is being re-defined herein to be restricted to including any specific characteristics of the features or aspects of the preferred embodiments with which that terminology is associated.

While preferred embodiments have been shown and described herein, it will be obvious to those skilled in the art that such embodiments are provided by way of example only. Numerous variations, changes, and substitutions will now occur to those skilled in the art without departing from the preferred embodiments. It should be understood that various alternatives to the preferred embodiments described herein could be employed in practicing the preferred embodiments. It is intended that the following claims define the scope of the preferred embodiments and that methods and structures within the scope of these claims and their equivalents be covered thereby.

What is claimed is:

1. A method for controlling a continuously variable transmission having a ball-planetary variator (CVP) provided with a ball in contact with a first traction ring assembly, a second traction ring assembly, and an idler assembly, wherein the continuously variable transmission is operably coupled to a pressurized hydraulic system, the method comprising the steps of:
receiving a plurality of input signals indicative of a CVP input speed and a CVP slip speed;
evaluating rate of change of the CVP slip speed;
determining a CVP slip state based on a fuzzy logic computation;
applying a plurality of fuzzy logic weighting coefficients indicative of the CVP slip state;
determining a hydraulic pressure setpoint based on the plurality of fuzzy logic weighting coefficients; and
issuing the hydraulic pressure setpoint as a command to impart a change in an operating condition of the CVP.

2. The method of claim 1, wherein the hydraulic pressure setpoint is a commanded pressure for a lubricant supplied to the CVP.

3. The method of claim 1, wherein the hydraulic pressure setpoint is a commanded pressure for a hydraulic piston configured to apply clamp force to the CVP.

4. The method of claim 1, wherein determining a CVP slip state based on fuzzy logic computation further comprises forming a plurality of fuzzy logic membership sets.

5. The method of claim 4, wherein the plurality of fuzzy logic membership sets include a small slip speed membership set, a small slip rate of change membership set, a large slip speed membership set, and a large slip rate of change membership set.

6. The method of claim 5, wherein applying the plurality of fuzzy logic weighting coefficients further comprises applying a first rule function to the small slip rate change membership set and the small slip rate of change membership set to determine a minimum weighting coefficient.

7. The method of claim 6, wherein applying the plurality of fuzzy logic weighting coefficients further comprises applying a second rule function to the large slip rate change membership set and the large slip rate of change membership set to determine a maximum weighting coefficient.

8. The method of claim 7, wherein determining a hydraulic pressure setpoint based on the plurality of fuzzy logic weighting coefficients further comprises multiplying the minimum weighting coefficient by a minimum pressure constant, wherein the minimum pressure constant is based on a physical minimum pressure for the pressurized hydraulic system.

9. The method of claim 8, wherein determining a hydraulic pressure setpoint based on the plurality of fuzzy logic weighting coefficients further comprises multiplying the maximum weighting coefficient by a maximum pressure constant, wherein the maximum pressure constant is based on a physical maximum pressure for the pressurized hydraulic system.
